(19) United States
(12) Patent Application Publication
(10) Pub. No.: US 2024/0228347 A1
(43) Pub. Date: Jul. 11, 2024

(54) METHODS FOR NATURAL GAS INJECTION INTO WATER

(71) Applicant: ExxonMobil Technology and Engineering Company, Spring, TX (US)

(72) Inventor: Timothy J. NEDWED, Houston, TX (US)

(21) Appl. No.: 18/559,134

(22) PCT Filed: Feb. 3, 2022
(86) PCT No.: PCT/US2022/070493

§ 371 Date: Nov. 6, 2023

Related U.S. Application Data
(60) Provisional application No. 63/190,867, filed on May 20, 2021.

(51) Int. Cl. C02F 3/34; C02F 103/00; C02F 103/08; E21B 41/00; E21B 43/34

(52) U.S. Cl. CPC C02F 3/347; C02F 3/34; E21B 41/005; E21B 43/34; C02F 2103/007; C02F 2103/08; C02F 2209/22; C02F 2209/24; C02F 2209/285

(57) ABSTRACT

Disclosed herein are methods that include producing oil and natural gas from a subterranean formation; separating the oil and the natural gas; dissolving at least a portion of the natural gas in water; exposing microorganisms that consume hydrocarbons to the water having the natural gas dissolved therein; and allowing higher-level organisms to consume the microorganisms.

### CROSS-REFERENCE TO RELATED APPLICATION

This application is the U.S. National Stage Application of the International Application No. PCT/US2022/070493, entitled “METHODS FOR NATURAL GAS INJECTION INTO WATER,” filed on Feb. 3, 2022, the disclosure of which is hereby incorporated by reference in its entirety, which claims priority to and the benefit of U.S. Provisional Application No. 63/190,867 having a filing date of May 20, 2021, the disclosure of which is incorporated herein by reference in its entirety.

### FIELD OF THE INVENTION

The present disclosure relates to injecting natural gas produced at hydrocarbon production sites into water, which may reduce the transfer of greenhouse gas to the atmosphere and/or promote aquatic food chains.

### BACKGROUND OF THE INVENTION

Natural gas is often produced along with oil during hydrocarbon production. Typically, the oil has the higher market value and is far easier to transport via tankers. Accordingly, at hydrocarbon production sites, both on-shore and off-shore, the produced oil is separated from the produced natural gas. The produced oil is then transported to a location like a refinery for further processing. When gas markets are accessible, the produced natural gas is often transported to these markets.

However, if a gas market is not readily accessible, which is often the case for off-shore production sites particularly in new developments and those far from population centers, operators have limited options for what to do with the natural gas. One option is to flare (or burn) the natural gas on-site. In some instances, the natural gas is injected back into the hydrocarbon formation for enhanced oil recovery (EOR) processes. Additionally, the natural gas may be used on-site as an energy source for powering the equipment associated with hydrocarbon production. While the latter options are preferred, in many instances (e.g., where maintaining the pressure of the formation is not a priority or there is excess natural gas) flaring is implemented.

Flaring produces carbon dioxide, which is considered the primary greenhouse gas emitted through human activities. Alternative productive uses of natural gas that can be economically implemented at hydrocarbon production sites, both on-shore and off-shore, and that reduce carbon dioxide emissions would be of value to the industry.

### SUMMARY OF THE INVENTION

The present disclosure relates to injecting natural gas produced at hydrocarbon production sites into water, which may reduce the transfer of greenhouse gas to the atmosphere and/or promote aquatic food chains.

Disclosed herein are methods that comprise: producing oil and natural gas from a subterranean formation; separating the oil and the natural gas; dissolving at least a portion of the natural gas in water; exposing microorganisms that consume hydrocarbons to the water having the natural gas dissolved therein; and allowing higher-level organisms to consume the microorganisms.

Disclosed herein are methods that comprise: producing oil and natural gas from a subterranean formation; separating the oil and the natural gas; dissolving at least a portion of the natural gas in water; exposing microorganisms to the water having the natural gas dissolved therein; and allowing the microorganisms to continue in an aquatic food chain.

### BRIEF DESCRIPTION OF THE DRAWINGS

The following figures are included to illustrate certain aspects of the disclosure, and should not be viewed as exclusive configurations. The subject matter disclosed is capable of considerable modifications, alterations, combinations, and equivalents in form and function, as will occur to those skilled in the art and having the benefit of this disclosure.

FIG. 1 illustrates a diagram of an off-shore system suitable for implementing the methods of the present disclosure.

FIG. 2 illustrates a diagram of an on-shore system suitable for implementing the methods of the present disclosure.

### DETAILED DESCRIPTION OF THE INVENTION

The present disclosure relates to injecting natural gas produced at hydrocarbon production sites into water, which may reduce the transfer of greenhouse gas to the atmosphere and/or promote aquatic food chains. More specifically, the methods and systems of the present disclosure dissolve natural gas in water and allow microorganisms to consume the dissolved hydrocarbons commonly found in natural gas (e.g., methane, ethane, propane, butane, and the like). Such microorganisms may be bacteria, archaea, and fungi. Combinations of the foregoing may be present for consuming the dissolved natural gas.

The source of the natural gas may be the natural gas produced with oil that is traditionally flared, which creates carbon dioxide. When such natural gas sources are used, the hydrocarbons may advantageously be used as an energy source for—microorganisms where about half of the hydrocarbons are converted to cell material and half is converted to carbon dioxide. The carbon dioxide may then be consumed by phytoplankton. The phytoplankton incorporate a portion of the carbon from the carbon dioxide into cell material. This cell material will settle to the seabed when the phytoplankton dies. This can sequester the carbon for long periods and reduce the amount of greenhouse gas that reaches the atmosphere.

Further, the microorganisms may be suitable food for other organisms like zooplankton, thereby enhancing the natural food chain for higher-level organisms. That is, with increased levels of natural gas, the density of microorganisms increases, which increases the food supply for zooplankton and so on through the food chain. Additionally, the methods and systems described herein support the natural food chain by increasing the food for the microorganisms allowing the downstream food chain to benefit accordingly. That is, additional steps to convert the microorganisms to protein-rich food (or biomass) and direct food for higher-level organisms are avoided. Rather, the methods and systems described herein enhance the natural food chain directly.

Additionally, the methods and systems described herein may be applicable to any body of water (natural or man-made) containing microorganisms capable of utilizing natural gas as an energy source including oceans and seas as well as on-shore bodies of water like lakes, streams, rivers, fishery tanks, and the like.

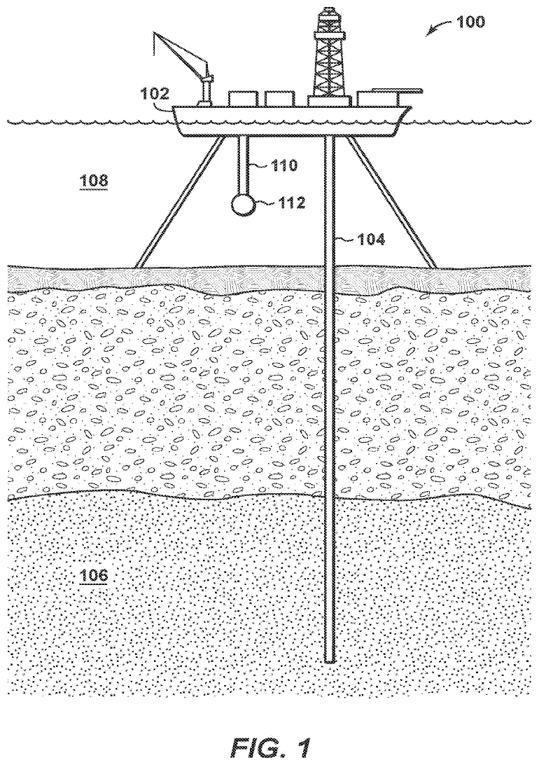

FIG. 1 illustrates a diagram of an off-shore system 100 suitable for implementing the methods of the present disclosure. The system 100 includes a platform 102 and a pipe and/or wellbore 104 penetrating a subterranean formation 106. Hydrocarbons comprising oil and natural gas from the subterranean formation 106 are conveyed to the platform 102 via the pipe and/or wellbore 104. On the platform, natural gas is extracted from the other hydrocarbons. The natural gas is then conveyed via line 110 to an outlet 112 positioned in the body of water 108 in which the platform 102 is located. The outlet 112 should be suitable for producing bubbles of sufficiently small size to cause the natural gas to rapidly dissolve in the water. The size requirements for the bubbles depends on, among other things, the temperature and pressure of the water and the depth of the outlet 112. The depth of the outlet may be about 10 feet from the surface of the body of water 108 to about 3,000 feet (or deeper) from the surface of the body of water 108 (or about 10 feet to about 1,000 feet, or about 100 feet to about 500 feet, or about 500 feet to about 1,500 feet, about 750 feet to about 1,250 feet, about 1,500 feet to about 3,000 feet). Further, in an off-shore system 100, ocean currents may aid in dispersing and diluting the dissolved methane in said body of water.

Once the natural gas is dissolved and dispersed in the body of water 108, microorganisms in the body of water 108 consume the natural gas. Then, organisms such as zooplankton consume the microorganisms. Then, higher-level organisms consume the organisms that consumed the microorganisms, and so on through the natural aquatic food chain. Notably, the systems and methods do not include harvesting the microorganisms and processing the microorganisms into a protein-rich food. Rather, the systems and methods described herein promote the natural aquatic food chain directly.

The microorganisms consume the natural gas and produce cellular matter and carbon dioxide. Said carbon dioxide is dissolved in the body of water 108 and more likely to be consumed by phytoplankton and other aquatic plants than reach the surface of the body of water 108 to be released to the atmosphere. Accordingly, said systems and methods reduce, if not eliminate, the produced natural gas that is flared and the resultant carbon dioxide emissions while supporting the aquatic food chain.

Microorganisms that consume the natural gas include bacteria, archaea, fungi, and combinations thereof. The microorganisms may consume one or more hydrocarbons of the natural gas and using one or more biological pathways. For example, a microorganism may combine oxygen and methane to form formaldehyde. In another example, a microorganism may anaerobically oxidize methane. Further, the microorganisms that consume the natural gas may alone oxidize the methane or may use a syntrophic partner. Specific examples of microorganisms that consume the natural gas may include, but are not limited to, gammaproteobacteri, alphaproteobacteria, methylacidiphilaceae, methanosarcinales, candidatus methylomirabilis oxyfera, methylococcus capsulatus, and the like, and any combination thereof.

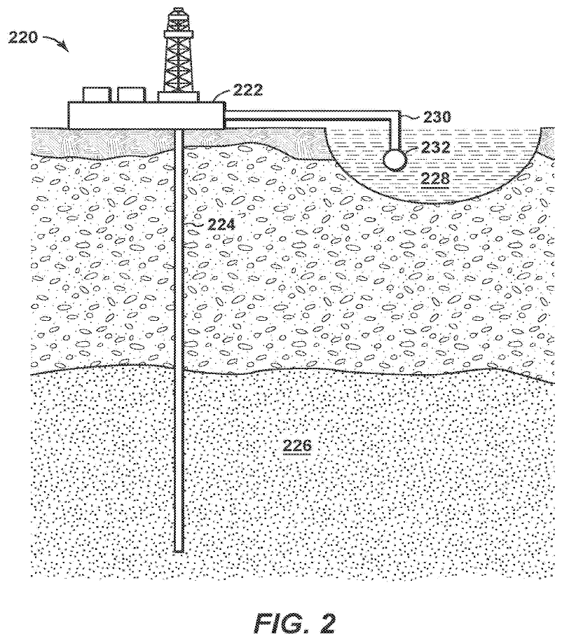

FIG. 2 illustrates a diagram of an on-shore system 220 suitable for implementing the methods of the present disclosure. The system 220 includes a platform 222 and a wellbore 224 penetrating a subterranean formation 226. Hydrocarbons comprising oil and natural gas from the subterranean formation 226 are conveyed to the platform 222 via the wellbore 224. On the platform, natural gas is extracted from the other hydrocarbons. The natural gas is then conveyed via line 230 to an outlet 232 positioned in a nearby body of water 228. The outlet 232 should be suitable for producing bubbles of sufficiently small size to cause the natural gas to rapidly dissolve in the water. The size requirements for the bubbles depends on, among other things, the temperature and pressure of the water and the depth of outlet 232.

As with the system 100 of FIG. 1, once the natural gas is dissolved and dispersed in the body of water 228, microorganisms in the body of water 228 consume the natural gas. Then, higher-level organisms such as zooplankton consume the microorganisms. Then, another set of higher-level organisms consume the zooplankton that consumed the microorganisms, and so on through the natural food chain. A higher-level organism refers to a natural organism in the environment that would consume the organism of interest within the natural food chain. For example, zooplankton consume algae and bacteria and, therefore, are higher-level organisms than algae and bacteria. Further, fish consume zooplankton and, therefore, are higher-level organisms than zooplankton.

Notably, the systems and methods do not include harvesting the microorganisms and converting the microorganisms into protein-rich food. Rather, the systems and methods described herein promote the natural aquatic food chain directly.

The microorganisms consume the natural gas and produce cellular matter and carbon dioxide. Said carbon dioxide is dissolved in the body of water 228 and more likely to be consumed by phytoplankton and other aquatic plants than reach the surface of the body of water 228 to be incorporated in the atmosphere. Accordingly, said systems and methods reduce, if not eliminate, the produced natural gas that is flared and resultant carbon dioxide emissions while supporting the aquatic food chain directly.

The body of water 228 may be man-made, natural, or a combination thereof. Examples of suitable bodies of water 228 may include, but are not limited to, ponds, lakes, marshes, bayous, seas, oceans, streams, rivers, fishery tanks, and the like.

In the systems and methods of the present disclosure, the amount of natural gas treated according to said systems and methods is about 25 vol % or more (or about 25 vol % to about 100 vol %, or about 50 vol % to about 100 vol %, or about 75 vol % to about 100 vol %, or about 90 vol % to about 100 vol %) of the produced natural gas not sent to a natural gas market.

The foregoing systems 100 and 220 illustrate the direct dissolution of the natural gas in the water of the body of water. However, the natural gas may be dissolved in water prior to conveying said water having natural gas dissolved therein to the body of water having the microorganisms therein.

Further, the foregoing systems 100 and 220 discuss producing bubbles to facilitate the dissolution of the natural gas in water by increasing the surface area between the natural gas and the water. In such methods, the pressure and temperature of the water will affect the concentration of natural gas that can be dissolved in the water and the size of the bubbles needed to facilitate dissolution of the natural gas before the natural gas reaches the surface of the water where it may enter the atmosphere. Advantageously, off-shore systems and methods have a greater depth and volume, which may allow for greater amounts of natural gas to be utilized in the methods and systems of the present disclosure. For on-shore systems and methods, the bubble size may need to be much smaller (e.g., microbubbles or nanobubbles), and/or the natural gas may be dissolved in water before introduction to the body of water containing the microorganisms to mitigate release of natural gas into the atmosphere. Further, on-shore methods and systems may have a maximum rate or volume of natural gas that can be treated so as not to cause the natural gas concentration dissolved in the water to be too high and toxic to aquatic organisms. For both off-shore and on-shore systems and methods, the outlet for the natural gas into the body of water may be a plurality of outlets in a localized area but spaced to mitigate toxicity to aquatic life at an individual outlet.

Additionally, the foregoing systems 100 and 220 illustrate introduction of the natural gas to a single body of water in only one location. However, the natural gas (whether for dissolution or already dissolved in water) may be introduced to the body of water in multiple locations and/or may be introduced to multiple bodies of water. For example, in an on-shore fishery system, a manifold may be used to introduce the natural gas (whether for dissolution or already dissolved in water) into a plurality of tanks or other fish-containment apparatuses.

Dissolution of the natural gas into the water may also be achieved with a continuous flow stirred mixing chamber. Here, the natural gas may be dissolved in water prior to releasing to a water body. Further, increasing the pressure in said mixing chamber (e.g., using a pressure cell) may be beneficial as the solubility of the natural gas increases with pressure.

In yet another example, a counter-current system may also be used to dissolve the natural gas in water prior to release into the body of water. For example, a natural gas stream may be injected at the base of a tall vessel while the water flows from the top to the bottom.

In either of the foregoing examples of dissolution of the natural gas into the water, the outlet options described relative to bubbles (e.g., a plurality of outlets in a local area and/or spaced further apart) may be applied for outlets that introduce the water having natural gas dissolved therein into the body of water.

Further, combinations of one or more of the methods and systems for dissolving natural gas in water and/or the body of water may be implemented in a single method and/or a single system.

The systems and methods described herein may also include a variety of sensors, for example, to detect the presence, absence, and/or amount of natural gas in the atmosphere above the body of water at one or more locations, to detect the concentration of dissolved natural gas in the body of water at one or more locations, to detect the concentration of dissolved carbon dioxide in the body of water at one or more locations, to detect the concentration of dissolved oxygen in the body of water at one or more locations, to detect the concentration of other nutrients in the body of water at one or more locations, and the like, and any combination thereof.

Various aspects of the systems and methods described herein may utilize computer systems, such as to process data received from the system (e.g., sensors, equipment associated with hydrocarbon production, equipment associated with natural gas separation from the produced hydrocarbons, and the like) to determine operational parameters (e.g., natural gas pressure, bubble size, natural gas flow rate, and the like) of the methods and systems described herein. Such systems and methods may include a non-transitory computer readable medium containing instructions that, when implemented, cause one or more processors to carry out the methods described herein.

“Computer-readable medium” or “non-transitory, computer-readable medium,” as used herein, refers to any non-transitory storage and/or transmission medium that participates in providing instructions to a processor for execution. Such a medium may include, but is not limited to, non-volatile media and volatile media. Non-volatile media includes, for example, NVRAM, or magnetic or optical disks. Volatile media includes dynamic memory, such as main memory. Common forms of computer-readable media include, for example, a floppy disk, a flexible disk, a hard disk, an array of hard disks, a magnetic tape, or any other magnetic medium, magneto-optical medium, a CD-ROM, a holographic medium, any other optical medium, a RAM, a PROM, and EPROM, a FLASH-EPROM, a solid state medium like a memory card, any other memory chip or cartridge, or any other tangible medium from which a computer can read data or instructions. When the computer-readable media is configured as a database, it is to be understood that the database may be any type of database, such as relational, hierarchical, object-oriented, and/or the like. Accordingly, exemplary embodiments of the present systems and methods may be considered to include a tangible storage medium or tangible distribution medium and prior art-recognized equivalents and successor media, in which the software implementations embodying the present techniques are stored.

The methods described herein can be performed using computing devices or processor-based devices that include a processor; a memory coupled to the processor; and instructions provided to the memory, wherein the instructions are executable by the processor to perform the methods described herein. The instructions can be a portion of code on a non-transitory computer readable medium. Any suitable processor-based device may be utilized for implementing all or a portion of embodiments of the present techniques, including without limitation personal computers, networks of personal computers, laptop computers, computer workstations, mobile devices, multi-processor servers or workstations with (or without) shared memory, high performance computers, and the like. Moreover, embodiments may be implemented on application specific integrated circuits (ASICs) or very large scale integrated (VLSI) circuits.

A first non-limiting example embodiment is a method comprising: producing oil and natural gas from a subterranean formation; separating the oil and the natural gas; dissolving at least a portion of the natural gas in water; exposing microorganisms that consume hydrocarbons to the water having the natural gas dissolved therein; and allowing higher-level organisms to consume the microorganisms.

A second non-limiting example embodiment is a method comprising: producing oil and natural gas from a subterranean formation; separating the oil and the natural gas; dissolving at least a portion of the natural gas in water; exposing microorganisms to the water having the natural gas dissolved therein; and allowing the microorganisms to continue in an aquatic food chain.

The first and second non-limiting example embodiments may independently include one or more of: Element 1: wherein the microorganisms are located in an off-shore body of water; Element 2: wherein the microorganisms are located in an on-shore body of water; Element 3: Element 2 and wherein the on-shore body of water is associated with a fishery; Element 4: the method further comprising: producing bubbles with the natural gas in the water to facilitate the dissolving of the natural gas in the water; Element 5: the method further comprising: conveying the water having the natural gas dissolved therein to a body of water having the microorganisms therein; Element 6: wherein the water is a portion of a body of water having the microorganisms therein; Element 7: Element 6 further comprising: introducing the natural gas and/or the water having the natural gas dissolved therein at a depth of about 10 feet to about 3,000 feet below a surface of the body of water; Element 8: wherein the body of water further comprises phytoplankton that consume carbon dioxide produced by the microorganisms; Element 9: wherein the microorganisms comprise bacteria capable of metabolizing natural gas; Element 10: wherein the microorganisms comprise archaea capable of metabolizing natural gas; Element 11: wherein the microorganisms comprise fungi capable of metabolizing natural gas; Element 12: wherein the higher-level organisms comprise zooplankton; Element 13: the method further comprising: detecting, relative to a body of water having the microorganisms therein, one or more of: a presence, absence, and/or amount of natural gas in an atmosphere above the body of water at one or more locations; a concentration of dissolved natural gas in the body of water at one or more locations; a concentration of dissolved carbon dioxide in the body of water at one or more locations; a concentration of dissolved oxygen in the body of water at one or more locations; and a concentration of other nutrients in the body of water at one or more locations; Element 14: wherein the method does not include harvesting the microorganisms, and converting the microorganisms into a protein-rich food; and Element 15: wherein the at least a portion of the natural gas is 25 vol % or greater of an amount of natural gas produced and not transported to a natural gas market. Examples of combinations include, but are not limited to, Element 1 in combination with one or more of Elements 4-15; Element 2 (optionally in combination with Element 3) in combination with one or more of Elements 3-15; Element 5 in combination with one or more of Elements 6-15; Element 6 (optionally in combination with Element 7) in combination with one or more of Elements 8-15; Element 8 in combination with one or more of Elements 9-15; two or more of Elements 9-11 in combination; one or more of Elements 9-11 in combination with one or more of Elements 12-15; and two or more of Elements 12-15 in combination.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the incarnations of the present inventions. At the very least, and not as an attempt to limit the application of the doctrine of equivalents to the scope of the claim, each numerical parameter should at least be construed in light of the number of reported significant digits and by applying ordinary rounding techniques.

One or more illustrative incarnations incorporating one or more invention elements are presented herein. Not all features of a physical implementation are described or shown in this application for the sake of clarity. It is understood that in the development of a physical embodiment incorporating one or more elements of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

Therefore, the present invention is well adapted to attain the ends and advantages mentioned as well as those that are inherent therein. The particular examples and configurations disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

What is claimed is:

1. A method comprising:
producing oil and natural gas from a subterranean formation;
separating the oil and the natural gas;
dissolving at least a portion of the natural gas in water;
exposing microorganisms that consume hydrocarbons to the water having the natural gas dissolved therein; and
allowing higher-level organisms to consume the microorganisms.

2. The method of claim 1 further comprising:
producing bubbles with the natural gas in the water to facilitate the dissolving of the natural gas in the water.

3. The method of claim 1 further comprising:
conveying the water having the natural gas dissolved therein to a body of water having the microorganisms therein.

4. The method of claim 1, wherein the microorganisms are located in an off-shore body of water.

5. The method of claim 1, wherein the microorganisms are located in an on-shore body of water.

6. The method of claim 5, wherein the on-shore body of water is associated with a fishery.

7. The method of claim 1, wherein the body of water further comprises phytoplankton that consume carbon dioxide produced by the microorganisms.

8. The method of claim 1, wherein the microorganisms comprise bacteria capable of metabolizing natural gas.

9. The method of claim 1, wherein the microorganisms comprise archaea capable of metabolizing natural gas.

10. The method of claim 1, wherein the microorganisms comprise fungi capable of metabolizing natural gas.

11. The method of claim 1, wherein the higher-level organisms comprise zooplankton.

12. The method of claim 1 further comprising:
detecting, at one or more locations, a presence, an absence, and/or an amount of natural gas in an atmosphere above a body of water having the microorganisms therein.

13. The method of claim 1 further comprising:
detecting, at one or more locations, a concentration of dissolved natural gas in a body of water having the microorganisms therein.

14. The method of claim 1 further comprising:
detecting, at one or more locations, a concentration of dissolved natural gas, carbon dioxide and/or oxygen in a body of water having the microorganisms therein.

15. The method of claim 1 further comprising:
detecting, at one or more locations, a concentration of nutrients in a body of water having the microorganisms therein.

16. The method of claim 1, wherein the method does not include harvesting the microorganisms, and converting the microorganisms into a protein-rich food.

17. The method of claim 1, wherein the at least a portion of the natural gas is 25 vol % or greater of an amount of natural gas produced and not transported to a natural gas market.

18. A method comprising:
producing oil and natural gas from a subterranean formation;
separating the oil and the natural gas;
dissolving at least a portion of the natural gas in water;
exposing microorganisms that consume hydrocarbons to the water having the natural gas dissolved therein; and
allowing the microorganisms to continue in an aquatic food chain.

19. The method of claim 18 further comprising:
producing bubbles with the natural gas in the water to facilitate the dissolving of the natural gas in the water.

20. The method of claim 18 further comprising:
conveying the water having the natural gas dissolved therein to a body of water having the microorganisms therein.
